(19) United States
(12) Patent Application Publication
(10) Pub. No.: US 2012/0137825 A1
(43) Pub. Date: Jun. 7, 2012

(54) Bicycle pedal

(76) Inventor: Chang Hui Lin, Changhua Hsien (TW)

(21) Appl. No.: 12/928,053

(22) Filed: Dec. 2, 2010

(51) Int. Cl. B62M 3/08

(52) U.S. Cl. 74/594.4

(57) ABSTRACT

A bicycle pedal includes a lateral spindle parallel to an X-axis and perpendicular to a Y-axis the X-axis, and includes an inclined surface formed in the inner and front side portion and tilted outwardly and tilted relative to the Y-axis for a tilting angle “A” ranged from five (5) to twenty five (25) degrees, and includes another inclined surface formed in the outer and rear side portion and tilted inwardly and tilted relative to the Y-axis and parallel to the feet of the user for suitably supporting the feet of the user and for allowing the pedal members to be suitably or effectively stepped or actuated by the user, and includes one or more air passages, air pathways or openings for air circulating purposes.

### BACKGROUND OF THE INVENTION

1. Field of the Invention

The present invention relates to a bicycle pedal, and more particularly to a bicycle pedal including an outwardly extended structure or configuration for suitably supporting the shoes or the feet of the user and for allowing the bicycle pedal to be suitably or effectively stepped or actuated by the user.

2. Description of the Prior Art

Typical bicycle pedals comprise a pedal body pivotally or rotatably attached or mounted or secured or supported on a pedal supporting spindle for engaging with the shoes or the feet of the user and for allowing the pedal bodies to be suitably stepped or actuated by the user.

For example, U.S. Pat. No. 550,409 to Hanson, U.S. Pat. No. 1,352,446 to Glanz, U.S. Pat. No. 4,873,890 to Nagano, and U.S. Pat. No. 6,708,584 to Muraoka disclose several of the typical bicycle pedals each also comprising a pedal body pivotally or rotatably attached or mounted or secured or supported on a pedal supporting spindle for engaging with the shoes or the feet of the user and for allowing the pedal bodies to be suitably stepped or actuated by the user.

Normally, the pedal bodies are disposed or arranged perpendicular to the pedal supporting spindle and may be suitably stepped or actuated by the user when the feet of the user are also perpendicular to the pedal supporting spindle.

However, the toe portions of the feet of the user are normally located slightly outwardly relative to the heel portions of the feet of the user such that the pedal bodies may not be used to suitably support the feet of the user, or such that the feet of the user may not be suitably engaged onto the pedal bodies, and such that the pedal bodies may not be suitably or effectively stepped or actuated by the user.

The present invention has arisen to mitigate and/or obviate the afore-described disadvantages of the conventional pedal members for the bicycles.

### SUMMARY OF THE INVENTION

The primary objective of the present invention is to provide a bicycle pedal including an outwardly extended structure or configuration for suitably supporting the shoes or the feet of the user and for allowing the bicycle pedal to be suitably or effectively stepped or actuated by the user.

In accordance with one aspect of the invention, there is provided a bicycle pedal comprising a pedal body including a spindle laterally and rotatably disposed therein and parallel to an X-axis of the pedal body, and including a Y-axis perpendicular to the X-axis of the pedal body, the pedal body including an upper surface, a bottom surface, a front portion, a rear portion, an inner and front side portion, an inner and rear side portion, an outer and front side portion, and an outer and rear side portion, and the pedal body including a first inclined surface provided in the inner and front side portion thereof and tilted outwardly and tilted relative to the Y-axis of the pedal body for a tilting angle “A”, and including a second inclined surface provided in the outer and rear side portion thereof and tilted inwardly and tilted relative to the Y-axis of the pedal body and parallel to the feet of the user for suitably supporting the feet of the user and for allowing the pedal members to be suitably or effectively stepped or actuated or operated by the user.

The tilting angle “A” of the first inclined surface of the pedal body is ranged from five (5) to twenty five (25) degrees. The second inclined surface is preferably parallel to the first inclined surface of the pedal body, and is tilted inwardly and tilted relative to the Y-axis of the pedal body for a tilting angle ranged from five (5) to twenty five (25) degrees.

The pedal body includes a number of pegs extended upwardly from the upper surface thereof for frictionally engaging with the feet of the user, and includes a number of pegs extended downwardly from the bottom surface thereof for frictionally engaging with the feet of the user. The bottom surface of the pedal body is preferably, but not necessarily parallel to the upper surface of the pedal body.

The pedal body includes a notch formed in the inner and rear side portion thereof for weight reducing purposes, and includes a notch formed in the outer and front side portion thereof for weight reducing purposes. The front portion of the pedal body is recessed, and the pedal body includes at least one air passage formed in the front portion thereof, and includes a number of depressions formed in the front portion thereof and communicative with the at least one air passage thereof.

The rear portion of the pedal body is recessed, and the pedal body includes at least one air passage formed in the rear portion thereof, and includes a number of depressions formed in the rear portion thereof and communicative with the at least one air passage thereof.

The pedal body includes at least one opening formed in the upper surface thereof for air permitting or circulating purposes, and includes at least one opening formed in the bottom surface thereof for air permitting or circulating purposes.

The pedal body includes at least one air pathway formed in the inner and front side portion thereof, and includes at least one air pathway formed in the inner and rear side portion thereof, and includes at least one air pathway formed in the outer and front side portion thereof, and includes at least one air pathway formed in the outer and rear side portion thereof.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a perspective view of a bicycle pedal in accordance with the present invention;

FIG. 2 is a top plan schematic view of the bicycle pedal;

FIG. 3 is a rear plan schematic view of the bicycle pedal;

FIG. 4 is a partial cross sectional view of the bicycle pedal taken along lines 4-4 of FIG. 3; and

FIG. 5 is an exploded and top plan schematic view illustrating the pair of the pedals for the bicycle, and illustrating the operation of the bicycle pedals.

### DETAILED DESCRIPTION OF THE PREFERRED EMBODIMENT

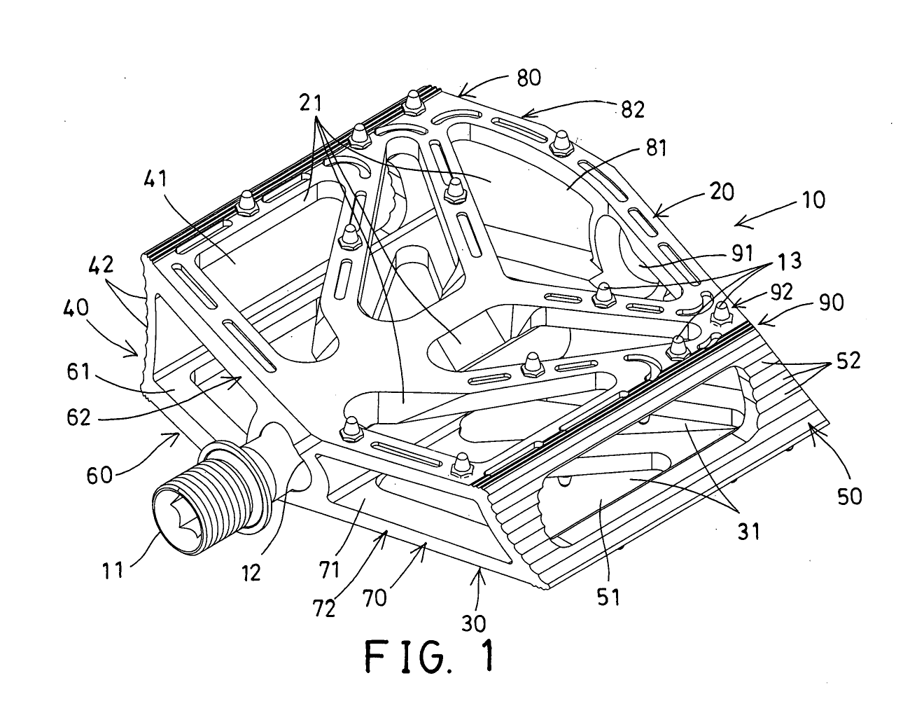

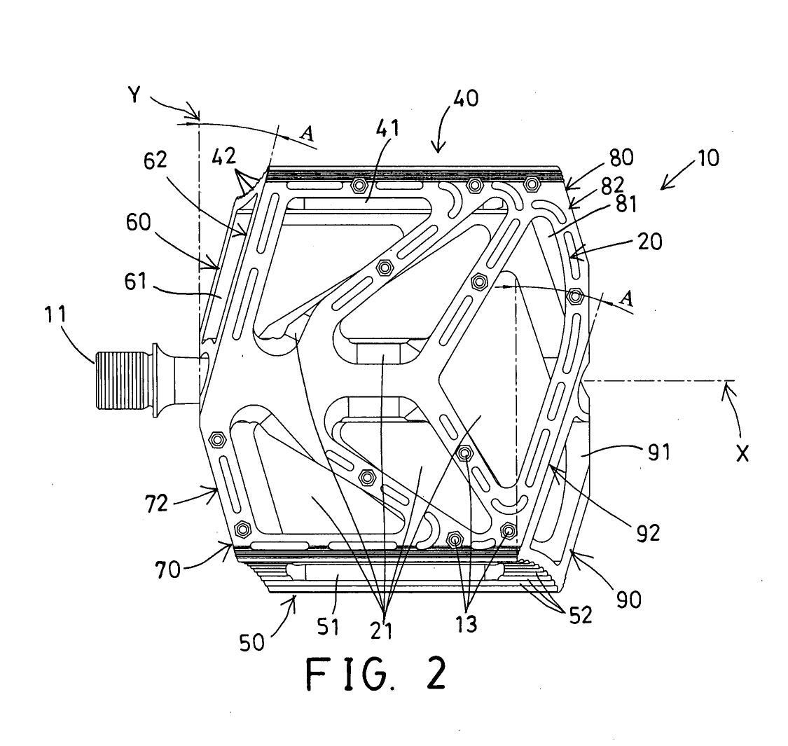

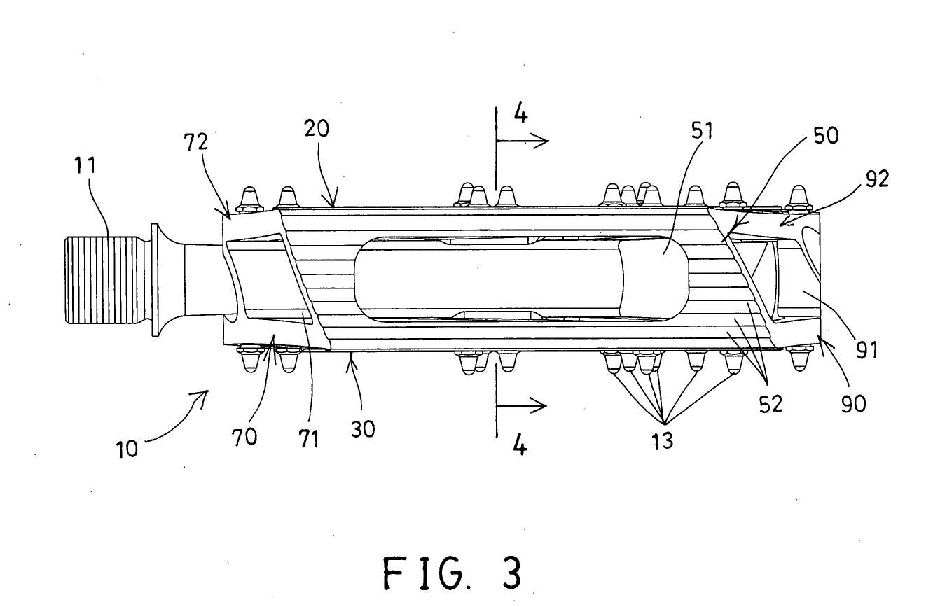

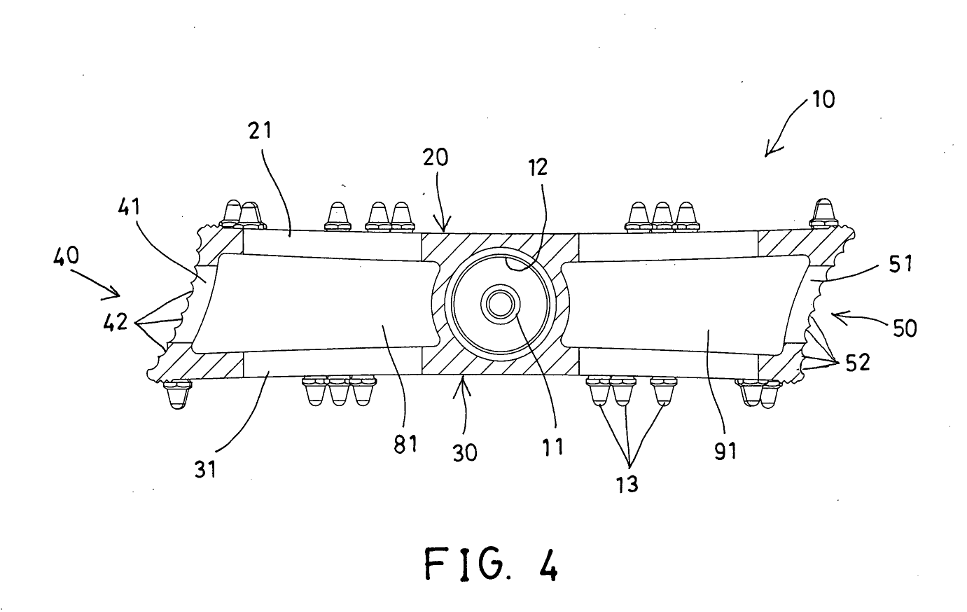

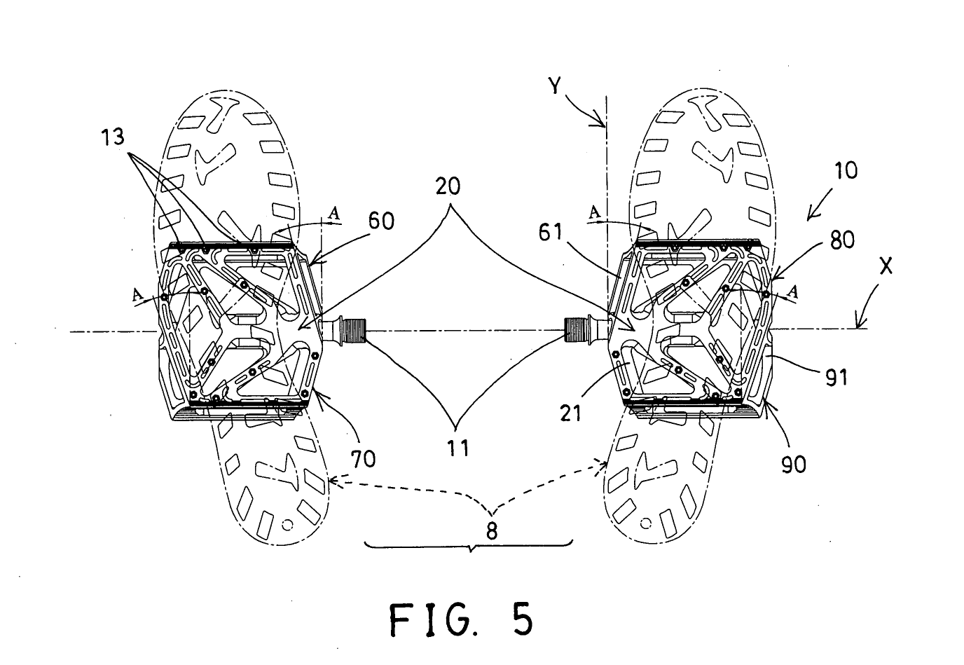

Referring to the drawings, and initially to FIGS. 1-4, a bicycle pedal in accordance with the present invention comprises a pedal body 10 including a spindle 11 laterally disposed therein and engaged in a lateral groove 12 thereof (FIGS. 1, 4), in which the spindle 11 is located at and defined as or parallel to the X-axis of the pedal body 10, and a Y-axis of the pedal body 10 is perpendicular to the X-axis of the pedal body 10, the pedal body 10 is pivotal or rotatable relative to the spindle 11, and includes an upper portion or surface 20, a bottom portion or surface 30 preferably, but not necessarily be parallel to the upper portion or surface 20, a recessed or concave front portion 40, a recessed or concave rear portion 50 preferably, but not necessarily be parallel to the front portion 40, an inner and front side portion 60, an inner and rear side portion 70, an outer and front side portion 80, and an outer and rear side portion 90, and includes a number of projections or spikes or pegs 13 extended upwardly and downwardly from the upper and the bottom portions or surfaces 20, 30 respectively. As shown in FIG. 5, a bicycle (not shown) normally may include a pair of pedal bodies 10 having a configuration mirror symmetric with each other or relative to each other.

The pedal body 10 includes one or more openings 21 formed or provided in the upper portion or surface 20 thereof for air permitting or circulating purposes, and includes one or more openings 31 formed or provided in the bottom portion or surface 30 thereof for air permitting or circulating purposes, and includes one or more air passages 41, 51 formed or provided in each of the front and the rear portions 40, 50 thereof for air permitting or circulating purposes, and includes one or more air pathways 61, 71, 81, 91 formed or provided in each of the front and rear side portions 60, 70, 80, 90 thereof for air permitting or circulating purposes, and includes a number of recessed or curved depressions 42, 52 formed or provided in each of the front and the rear portions 40, 50 thereof and communicative with the air passages 41, 51 for guiding the air to flow into and through the air passages 41, 51 of the pedal body 10 respectively.

The pedal body 10 includes a cut-off portion or tilted or inclined surface 62 formed or provided in the inner and front side portion 60 and tilted or inclined outwardly or relative to the Y-axis of the pedal body 10 for a tilting angle “A” ranged from five (5) to twenty five (25) degrees, and also includes a cut-off portion or tilted or inclined surface 92 formed or provided in the outer and rear side portion 90 and tilted or inclined inwardly or relative to the Y-axis of the pedal body 10 for a tilting angle “A” ranged from five (5) to twenty five (25) degrees, and it is preferable, but not necessarily that the tilted or inclined surfaces 62, 92 in the inner and front side portion 60 and the outer and rear side portion 90 are parallel to each other.

As also shown in FIG. 5, the pair of pedal bodies 10 are mirror symmetric to each other and tilted or inclined outwardly and substantially parallel to the feet 8 of the user for suitably supporting the feet 8 of the user and for allowing the pair of pedal bodies 10 of the bicycle pedal to be suitably or effectively stepped or actuated by the user. The pedal body 10 may further include a cut-off portion or notch 72 formed or provided in the inner and rear side portion 70 thereof, and may further include another cut-off portion or notch 82 formed or provided in the outer and front side portion 80 thereof for weight reducing purposes, or for preventing the pedal bodies 10 from being contacted or interfered by the other objects.

Accordingly, the bicycle pedal in accordance with the present invention includes an outwardly extended structure or configuration for suitably supporting the shoes or the feet of the user and for allowing the bicycle pedal to be suitably or effectively stepped or actuated by the user.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A bicycle pedal comprising:
a pedal body including a spindle laterally and rotatably disposed therein and parallel to an X-axis of said pedal body, and including a Y-axis perpendicular to said X-axis of said pedal body,
said pedal body including an upper surface, a bottom surface, a front portion, a rear portion, an inner and front side portion, an inner and rear side portion, an outer and front side portion, and an outer and rear side portion, and
said pedal body including a first inclined surface provided in said inner and front side portion thereof and tilted outwardly and tilted relative to said Y-axis of said pedal body for a tilting angle “A”, and including a second inclined surface provided in said outer and rear side portion thereof and tilted inwardly and tilted relative to said Y-axis of said pedal body.

2. The bicycle pedal as claimed in claim 1, wherein said tilting angle “A” of said first inclined surface of said pedal body is ranged from five (5) to twenty five (25) degrees.

3. The bicycle pedal as claimed in claim 2, wherein said second inclined surface is parallel to said first inclined surface of said pedal body.

4. The bicycle pedal as claimed in claim 1, wherein said second inclined surface is tilted inwardly and tilted relative to said Y-axis of said pedal body for a tilting angle ranged from five (5) to twenty five (25) degrees.

5. The bicycle pedal as claimed in claim 1, wherein said pedal body includes a plurality of pegs extended upwardly from said upper surface thereof.

6. The bicycle pedal as claimed in claim 1, wherein said pedal body includes a plurality of pegs extended downwardly from said bottom surface thereof.

7. The bicycle pedal as claimed in claim 1, wherein said bottom surface of said pedal body is parallel to said upper surface of said pedal body.

8. The bicycle pedal as claimed in claim 1, wherein said pedal body includes a notch formed in said inner and rear side portion thereof.

9. The bicycle pedal as claimed in claim 1, wherein said pedal body includes a notch formed in said outer and front side portion thereof.

10. The bicycle pedal as claimed in claim 1, wherein said front portion of said pedal body is recessed, and said pedal body includes at least one air passage formed in said front portion thereof.

11. The bicycle pedal as claimed in claim 10, wherein said pedal body includes a plurality of depressions formed in said front portion thereof and communicative with said at least one air passage thereof.

12. The bicycle pedal as claimed in claim 1, wherein said rear portion of said pedal body is recessed, and said pedal body includes at least one air passage formed in said rear portion thereof.

13. The bicycle pedal as claimed in claim 12, wherein said pedal body includes a plurality of depressions formed in said rear portion thereof and communicative with said at least one air passage thereof.

14. The bicycle pedal as claimed in claim 1, wherein said pedal body includes at least one opening formed in said upper surface thereof.

15. The bicycle pedal as claimed in claim 1, wherein said pedal body includes at least one opening formed in said bottom surface thereof.

16. The bicycle pedal as claimed in claim 1, wherein said pedal body includes at least one air pathway formed in said inner and front side portion thereof, and includes at least one air pathway formed in said inner and rear side portion thereof, and includes at least one air pathway formed in said outer and front side portion thereof, and includes at least one air pathway formed in said outer and rear side portion thereof.
